(19) United States
(12) Patent Application Publication
(10) Pub. No.: US 2024/0134229 A1
(43) Pub. Date: Apr. 25, 2024

(54) DISPLAY DEVICE

(71) Applicant: TCL CHINA STAR OPTOELECTRONICS TECHNOLOGY CO., LTD., Shenzhen, Guangdong (CN)

(72) Inventor: Bo Hai, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/755,144

(22) PCT Filed: Mar. 14, 2022
(86) PCT No.: PCT/CN2022/080875

§ 371 Date: Apr. 20, 2022

(30) Foreign Application Priority Data
Mar. 7, 2022 (CN) 202210215249.9

(51) Int. Cl. G02F 1/13363; G02F 1/1335; G02F 1/1337

(52) U.S. Cl. CPC G02F 1/13363; G02F 1/133528; G02F 1/1337

(57) ABSTRACT

A display device is provided. A liquid crystal compensation layer is disposed on each of a first polarizer and a second polarizer. The liquid crystal compensation layers adjust compensation values through refractive index differences and thicknesses of liquid crystal molecules, so adjustment ranges are large and limitations are few, and the liquid crystal compensation layers can be matched with high phase differences of a liquid crystal display panel. Opposite two sides of the liquid crystal display panel are arranged symmetrically, number and thickness of film layers on each side is the same, so that a situation of bending due to different stress on the two sides of the liquid crystal display panel can be prevented.

### BACKGROUND OF INVENTION

### 1. Field of Invention

The present invention relates to a technical field of displays, and particularly to a display device.

### 2. Related Art

Contrast of current vertical alignment liquid crystal display devices at side viewing angles are poor, thus adversely affecting image quality of liquid crystal display devices. Particularly, with development of televisions of high dynamic range images, demands for contrast of liquid crystal display devices are higher. Therefore, a trend in development of panel industries in the future is improvement in the contrast of liquid crystal display devices.

Poor contrast of conventional vertical alignment liquid crystal display panels at side viewing angles are mainly stemmed from light leakage at the side viewing angles in a dark state. As viewing angles of thin-film transistor liquid crystal display panels increase, image contrast will continue to be lowered, along with a decrease in image clarity. This is because birefringence of liquid crystal molecules in liquid crystal layers changes subjected to observation angles. Using wide viewing angle compensation films for compensation can effectively reduce the light leakage of image display in the dark state, and can greatly improve image contrast within a certain viewing angle range. The compensation principle of compensation films is to correct phase differences generated by liquid crystal molecules at different viewing angles, so that birefringence properties of the liquid crystal molecules can be compensated symmetrically. However, conventional compensation films work with optical compensation. Optical compensation adjusts compensation values by stretching film layers. Due to limitations of film stretching, the compensation values are also limited, which cannot match phase differences of vertical alignment liquid crystal display devices. Therefore, effects of improving the light leakage of the vertical alignment liquid crystal display devices at side viewing angles in the dark state is limited.

### SUMMARY OF INVENTION

An object of the present application is to provide a display device to overcome a problem of light leakage at side viewing angles in a dark state.

The present application provides a display device, including a first polarizer, a second polarizer disposed opposite to the first polarizer, and a liquid crystal display panel disposed between the first polarizer and the second polarizer. The first polarizer includes a first liquid crystal compensation layer and a first optical compensation layer. The second polarizer includes a second liquid crystal compensation layer and a second optical compensation layer.

Optionally, in some embodiments of the present application, the first polarizer further includes a first polarizing layer. The first liquid crystal compensation layer and the first optical compensation layer are located between the first polarizing layer and the liquid crystal display panel. The second polarizer further includes a second polarizing layer. The first liquid crystal compensation layer and the first optical compensation layer are located between the first polarizing layer and the liquid crystal display panel.

Optionally, in some embodiments of the present application, each of the first liquid crystal compensation layer and the second liquid crystal compensation layer includes a liquid crystal polymer.

Optionally, in some embodiments of the present application, the first liquid crystal compensation layer is located between the first polarizing layer and the first optical compensation layer, and the second liquid crystal compensation layer is located between the second polarizing layer and the second optical compensation layer.

Optionally, in some embodiments of the present application, the first polarizer further includes a first support layer disposed between the first polarizing layer and the first liquid crystal compensation layer, and the second polarizer further includes a second support layer disposed between the second polarizing layer and the second liquid crystal compensation layer.

Optionally, in some embodiments of the present application, the first optical compensation layer is located between the first polarizing layer and the first liquid crystal compensation layer, and the second liquid crystal compensation layer is located between the second polarizing layer and the second optical compensation layer.

Optionally, in some embodiments of the present application, the first polarizer further includes a first support layer arranged between the first liquid crystal compensation layer and the liquid crystal display panel, the second polarizer further includes a second support layer disposed between the second polarizing layer and the second liquid crystal compensation layer.

Optionally, in some embodiments of the present application, the first liquid crystal compensation layer is located between the first polarizing layer and the first optical compensation layer, and the second optical compensation layer is located between the second polarizing layer and the second liquid crystal compensation layer.

Optionally, in some embodiments of the present application, the first polarizer further includes a first support layer disposed between the first polarizing layer and the first liquid crystal compensation layer, and the second polarizer further includes a second support layer arranged between the second liquid crystal compensation layer and the liquid crystal display panel.

Optionally, in some embodiments of the present application, the first optical compensation layer is located between the first polarizing layer and the first liquid crystal compensation layer, and the second optical compensation layer is located between the second polarizing layer and the second liquid crystal compensation layer.

Optionally, in some embodiments of the present application, the first polarizer further includes a first support layer arranged between the first liquid crystal compensation layer and the liquid crystal display panel, and the second polarizer further includes a second support layer arranged between the second liquid crystal compensation layer and the liquid crystal display panel.

Optionally, in some embodiments of the present application, the first polarizer further includes a first protective layer located on a side of the first polarizing layer away from the liquid crystal display panel, and the second polarizer further includes a second protective layer located on a side of the second polarizing layer away from the liquid crystal display panel.

Optionally, in some embodiments of the present application, the first protective layer and the second protective layer are made of triacetate cellulose, polymethyl methacrylate, or polyethylene terephthalate.

Optionally, in some embodiments of the present application, each of the first optical compensation layer and the second optical compensation layer includes a single optical axis compensation film or a dual optical axis compensation film.

The present application further provides a display device, including a first polarizer, a second polarizer disposed opposite to the first polarizer, and a liquid crystal display panel disposed between the first polarizer and the second polarizer. The first polarizer includes a first liquid crystal compensation layer and a first optical compensation layer. The second polarizer includes a second liquid crystal compensation layer and a second optical compensation layer. The first polarizer serves as a light incident side and the second polarizer serves as a light output side.

Optionally, in some embodiments of the present application, the first polarizer further includes a first polarizing layer. The first liquid crystal compensation layer and the first optical compensation layer are located between the first polarizing layer and the liquid crystal display panel, and the second polarizer further includes a second polarizing layer. The first liquid crystal compensation layer and the first optical compensation layer are located between the first polarizing layer and the liquid crystal display panel.

Optionally, in some embodiments of the present application, the first liquid crystal compensation layer is located between the first polarizing layer and the first optical compensation layer, and the second liquid crystal compensation layer is located between the second polarizing layer and the second optical compensation layer.

Optionally, in some embodiments of the present application, the first polarizer further includes a first support layer disposed between the first polarizing layer and the first liquid crystal compensation layer, and the second polarizer further includes a second support layer disposed between the second polarizing layer and the second liquid crystal compensation layer.

Optionally, in some embodiments of the present application, the first optical compensation layer is located between the first polarizing layer and the first liquid crystal compensation layer, and the second liquid crystal compensation layer is located between the second polarizing layer and the second optical compensation layer.

Optionally, in some embodiments of the present application, the first polarizer further includes a first support layer arranged between the first liquid crystal compensation layer and the liquid crystal display panel, and the second polarizer further includes a second support layer disposed between the second polarizing layer and the second liquid crystal compensation layer.

The present application has advantageous effects as follows: the present application provides the display device, including the first polarizer and the second polarizer disposed opposite to each other, and the liquid crystal display panel is disposed between the first polarizer and the second polarizer. The first polarizer includes the first liquid crystal compensation layer and the first optical compensation layer. The second polarizer includes the second liquid crystal compensation layer and the second optical compensation layer. On a basis of using a compensation film to symmetrically compensate for birefringence properties of liquid crystal molecules, the liquid crystal compensation layer is provided on each of the first polarizer and the second polarizer in the present application. The liquid crystal compensation layer is not used to increase a compensation value by stretching, but by adjusting refractive index differences and thicknesses of the liquid crystal molecules, so an adjustment range is large with few limitations, and the liquid crystal compensation layer can be matched with high phase differences of the liquid crystal display panel, thereby improving light leakage at side viewing angles in the dark state of the liquid crystal display panel, increasing contrast of the liquid crystal display panel, and improving image quality. In addition, two opposite sides of the liquid crystal display panel of the present application are symmetrically arranged, and number and thickness of film layers on each side of the liquid crystal display panel are the same, which can reduce bending caused by different stress on the two sides of the liquid crystal display panel.

### BRIEF DESCRIPTION OF DRAWINGS

In order to better illustrate the technical solutions in the embodiments of the present application, the following will briefly introduce the accompanying drawings that need to be used in the description of the embodiments. Apparently, the accompanying drawings in the following description show merely some embodiments of the present invention, and a person skilled in the art may still derive other drawings from these accompanying drawings without creative efforts.

FIG. 1 is a first schematic structural view of a display device provided by the present application.

FIG. 2 is a light leakage rendering view of a conventional display device at a dark state viewing angle.

FIG. 3 is a light leakage rendering view of a display device of the present application at a dark state viewing angle.

FIG. 4 is a second schematic structural view of a display device provided by the present application.

FIG. 5 is a third schematic structural view of a display device provided by the present application.

FIG. 6 is a fourth schematic structural view of a display device provided by the present application.

FIG. 7 is a fifth schematic structural view of a display device provided by the present application.

FIG. 8 is a sixth schematic structural view of a display device provided by the present application.

FIG. 9 is a seventh schematic structural view of a display device provided by the present application.

FIG. 10 is an eighth schematic structural view of a display device provided by the present application.

### DESCRIPTION OF PREFERRED EMBODIMENTS

The technical solutions in the embodiments of the present application will be clearly and completely described below in conjunction with the drawings in the embodiments of the present application. Obviously, the described embodiments are only a part of the embodiments of the present application, rather than all the embodiments. Based on the embodiments in this application, all other embodiments obtained by those skilled in the art without creative work shall fall within the protection scope of this application.

In the description of the present application, it is to be understood that the term “upper”, “lower”, “front”, “rear”, “left”, “right”, “inner”, “outer” indicates orientation or the orientation or positional relationship based on the positional relationship shown in the drawings, for convenience of description only and the present application is to simplify the description, but does not indicate or imply that the device or element referred to must have a particular orientation in a particular orientation construction and operation, and therefore not be construed as limiting the present application. In addition, the terms “first” and “second” are only used for descriptive purposes and are not to be construed as indicating or implying relative importance. Thus, features defining “first” or “second” may include one or more of the described features either explicitly or implicitly. In the description of the present invention, the meaning of “a plurality” is two or more unless specifically and specifically defined otherwise.

Poor side-viewing contrast of conventional vertical alignment liquid crystal display panels are mainly stemmed from light leakage at side viewing angles in a dark state. As viewing angles of a thin-film transistor liquid crystal display panel increase, image contrast will continue to be lowered, along with a decrease in image clarity. This is a result of changes in birefringence of liquid crystal molecules in a liquid crystal layer as the viewing angles change. On a basis of using a compensation film to symmetrically compensate for birefringence properties of liquid crystal molecules, the present application uses liquid crystal compensation layers to compensate for birefringence of liquid crystal molecules in a liquid crystal layer, the liquid crystal compensation layers adjust compensation values through refractive index differences and thicknesses of the liquid crystal molecules, so adjustment ranges are large and limitations are few, and the birefringence can be matched with high phase differences of a liquid crystal display panel, thereby improving light leakage at side viewing angles in a dark state of the liquid crystal display panel, increasing contrast of the liquid crystal display panel, and improving image quality.

The present application provides a display device, which will be described in detail below. It should be noted that the description order of the following embodiments is not intended to limit the preferred order of the embodiments of the present application.

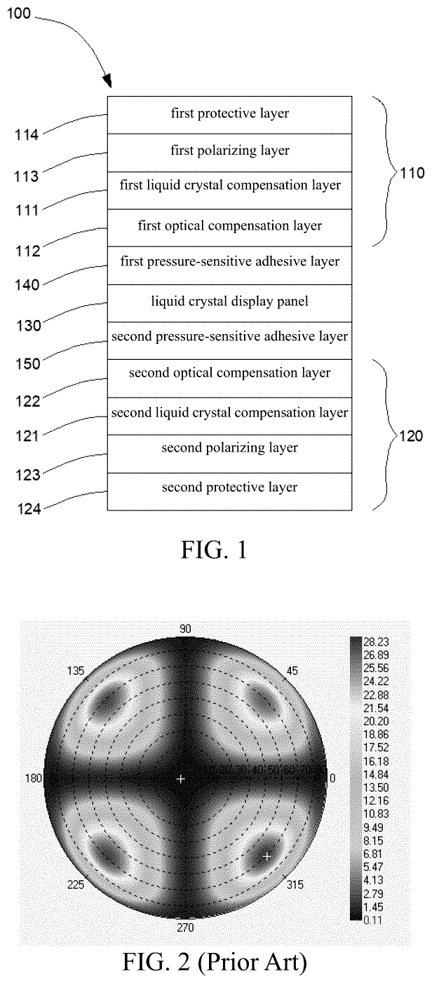

Please refer to FIG. 1, which is a first schematic structural view of a display device 100 provided by the present application. The present application provides the display device 100 including a first polarizer 110, a second polarizer 120, and a liquid crystal display panel 130.

The first polarizer 110 and the second polarizer 120 are disposed opposite to each other, and the liquid crystal display panel 130 is disposed between the first polarizer 110 and the second polarizer 120. The first polarizer 110 includes a first liquid crystal compensation layer 111 and a first optical compensation layer 112. The second polarizer 120 includes a second liquid crystal compensation layer 121 and a second optical compensation layer 122.

In some embodiments, the first polarizer 110 further includes a first polarizing layer 113, and the first liquid crystal compensation layer 111 and the first optical compensation layer 112 are located between the first polarizing layer 113 and the liquid crystal display panel 130. The second polarizer 120 further includes a second polarizing layer 123, and the second liquid crystal compensation layer 121 and the second optical compensation layer 122 are located between the second polarizing layer 123 and the liquid crystal display panel 130.

It can be understood that the liquid crystal display panel 130 includes a light incident side and a light output side. In this embodiment, the first polarizing layer 113 may serve as the light incident side, and the second polarizing layer 123 may serve as the light output side. Alternatively, the second polarizing layer 123 may also serve as the light incident side, and the first polarizing layer 113 may serve as the light emitting side, which is not limited in this application.

Specifically, an absorption axis of the first polarizing layer 113 is arranged at a first angle, and an absorption axis of the second polarizing layer 123 is arranged at a second angle. The first angle is one of 90 degrees and 0 degrees, and the second angle is the other one of 90 degrees and 0 degrees. The first polarizing layer 113 and the second polarizing layer 123 each are made of a polyvinyl alcohol film. Polyvinyl alcohol films have characteristics of high temperature and humidity resistance. The temperature and humidity resistance of the polyvinyl alcohol films can be achieved by adjusting the formula, stretching ratios, and stretching rates of polyvinyl alcohol iodine solution. In this way, a whole polarizer can have the characteristics of high temperature and humidity resistance. Specifically, a step of judging whether a polarizer has high temperature and humidity resistance is: taking a polarizer sample with a size of 40×40 millimeters (mm) for high temperature resistance characteristics. The polarizer sample is attached to a clean glass with a roller and placed in an environment of 80° C.×5 kilogram-force per square centimeter (kgf/cm2) for 15 minutes to determine whether the high temperature resistance of the polarizer sample at 80° C. and 500 hours meets the specification. For high humidity resistance, take a polarizer sample with a size of 40×40 mm. The polarizer sample is attached to a clean glass with a roller and placed in an environment of 80° C.×5 kgf/cm2 for 15 minutes to determine whether the high humidity resistance of the polarizer sample at 60° C., 90% relative humidity (RH), and 500 hours meets the specification, wherein a determination standard is that a variation rate of penetration of a monomer of the polarizer is less than or equal to 5%.

Each of the first optical compensation layer 112 and the second optical compensation layer 122 includes a single optical axis compensation film or a dual optical axis compensation film. The single optical axis compensation film is an anisotropic birefringent film with only one optical axis. The dual optical axis compensation film has two optical axes and three refractive indices. The dual optical axis compensation film has an in-plane phase difference value Ro and an out-of-plane phase difference value Rth in a thickness direction.

In some embodiments, the first optical compensation layer 112 and the second optical compensation layer 122 may be the same in structure. The first optical compensation layer 112 and the second optical compensation layer 122 each are single optical axis compensation films or dual optical axis compensation films. In other embodiments of the present application, the first optical compensation layer 112 and the second optical compensation layer 122 are different in structure. The first optical compensation layer 112 is a single optical axis compensation film and the second optical compensation layer 122 is a dual optical axis compensation film. Alternatively, the first optical compensation layer 112 is a dual optical axis compensation film and the second optical compensation layer 122 is a single optical axis compensation film.

Specifically, each of the first liquid crystal compensation layer 111 and the second liquid crystal compensation layer 121 includes a liquid crystal polymer. Compared with general photoelectric liquid crystal molecules, in terms of molecular structure, in addition to liquid crystal molecules, the liquid crystal polymer also has one or more reactive functional groups at ends of the liquid crystal molecules. The above combination can be photopolymerized into a polymer network, i.e., a liquid crystal polymer. Since most of polymerization initiators used are ultraviolet-sensitive (wavelength 254-365 nanometers (nm)), they are also called ultraviolet-reactive liquid crystals.

Traditional optical films are generally made of polymers that are extended uniaxially or biaxially, and an original random isotropic arrangement of molecular axes will be deflected to anisotropic with the extension direction, so that traveling speed of the incident light in different directions is different, that is, the phase delay phenomenon, which can be used to adjust or compensate for phases of light.

Generally, phase retardation can be calculated from a product of the difference Δn of a biaxial refractive index of a film and a thickness d of the film, that is, R=Δnd. Regardless of whether it is a rod-shaped or disc-shaped liquid crystal molecule, although overall anisotropy still depends on the arrangement rule, the birefringence of the liquid crystal is basically about 0.1. The birefringence is ten times or even a hundred times that of traditional polymer stretch film, so thickness of an optical film made by liquid crystal molecules can be very small, which is very Ideal for roll-to-roll coating processes.

Specifically, in some embodiments, the first liquid crystal compensation layer 111 and the second liquid crystal compensation layer 121 are formed by a coating process. General coating methods include wire rod coating, extrusion coating, direct gravure coating, reverse gravure coating, and die coating. Specifically, the coating process is as follows: a layer of alignment film is formed on a substrate, the alignment film is subjected to rubbing alignment treatment, and then a liquid crystal polymer is coated on the alignment film for alignment.

In addition, a fabrication process of the first liquid crystal compensation layer 111 and the second liquid crystal compensation layer 121 may also be as follows: the liquid crystal polymer is formed on the substrate, and then the liquid crystal polymer is cured and aligned by ultraviolet light. The process is quite simple and fast.

In the present application, the first polarizer 110 and the second polarizer 120 use compensation films to compensate for birefringence of the liquid crystal molecules in the liquid crystal layer, respectively. Generally, the compensation principle of compensation films is to correct phase differences generated by liquid crystal molecules at different viewing angles, so that birefringence properties of the liquid crystal molecules can be compensated symmetrically. Then, liquid crystal compensation layers are disposed on the first polarizer 110 and the second polarizer 120, respectively, and the birefringence of the liquid crystal molecules in the liquid crystal layer is compensated by the liquid crystal compensation layers. The liquid crystal compensation layer is not used to increase a compensation value by stretching, but by adjusting refractive index differences and thicknesses of the liquid crystal molecules, so an adjustment range is large with few limitations, and the birefringence can be matched with high phase differences of the liquid crystal display panel 130, thereby improving light leakage at side viewing angles in the dark state of the liquid crystal display panel 130, increasing contrast of the liquid crystal display panel 130, and improving image quality. In addition, two opposite sides of the liquid crystal display panel 130 of the present application are symmetrically arranged, and number and thickness of film layers on each side of the liquid crystal display panel are the same, which can reduce bending caused by different stress on both sides of the liquid crystal display panel 130.

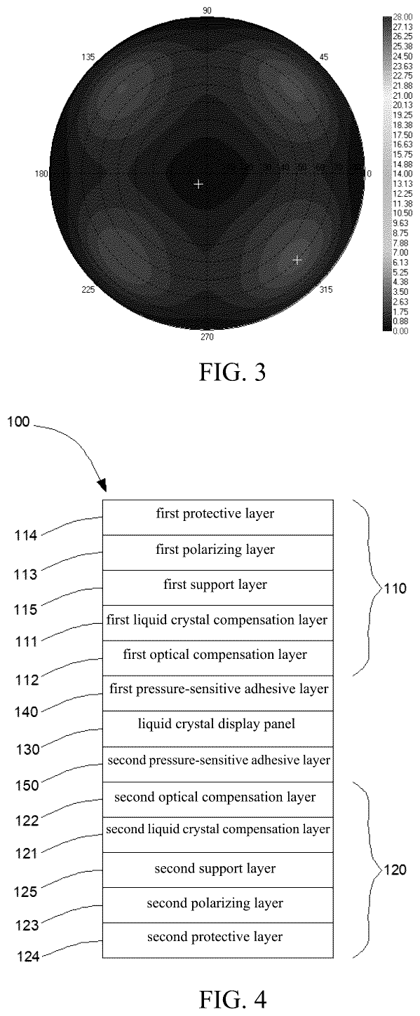

Referring to FIGS. 2 and 3, FIG. 2 is a light leakage rendering view of a conventional display device at a dark state viewing angle, and FIG. 3 is a light leakage rendering view of the display device 100 of the present application at a dark state viewing angle. Please refer to the following performance comparison table. By comparison, it is known that a maximum value of light leakage at the dark state viewing angle of a current display device is 28 nits, while a maximum value of light leakage at the dark state viewing angle of the display device 100 of the present application is 2.3 nits. Therefore, the present application can greatly improve light leakage at side viewing angles in the dark state of the liquid crystal display and increase contrast of the liquid crystal display, thus improving image quality.

Performance Comparison Table

| | | display device of the |
|---|---|---|
| | current display device | present application |
| maximum value | 28 nits | 2.3 nits |
| of light leakage | | |
| at a viewing angle | | |

Specifically, in some embodiments, the first liquid crystal compensation layer 111 is located between the first polarizing layer 113 and the first optical compensation layer 112. The second liquid crystal compensation layer 121 is located between the second polarizing layer 123 and the second optical compensation layer 122. That is, the first polarizing layer 113, the first liquid crystal compensation layer 111, and the first optical compensation layer 112 are sequentially laminated. The second polarizing layer 123, the second liquid crystal compensation layer 121, and the second optical compensation layer 122 are sequentially laminated.

Further, in some embodiments, the display device 100 further includes a first pressure-sensitive adhesive layer 140 attached to a side of the liquid crystal display panel 130 close to the first polarizing layer 113, and a second pressure-sensitive adhesive layer 150 attached to a side of the liquid crystal display panel 130 close to the second polarizing layer 123. A pressure-sensitive adhesive layer is provided as an adhesive between the liquid crystal display panel 130 and other layers. Applying slight pressure to the pressure-sensitive adhesive can achieve a good fixing effect in a short time, and an advantage of the pressure-sensitive adhesive is that it can wet a contact surface as quickly as a fluid and can function as a solid to prevent peeling. It should be noted that, as another embodiment of the present invention, the pressure-sensitive adhesive may not be included. Specifically, the first pressure-sensitive adhesive layer 140 and the second pressure-sensitive adhesive layer 150 each are polypropylene-based adhesives.

Still further, in some embodiments, the first polarizer 110 further includes a first protective layer 114 located on a side of the first polarizing 113 away from the liquid crystal display panel 130, and the second polarizer 120 further includes a second protective layer 124 located on a side of the second polarizer 123 away from the liquid crystal display panel 130. Specifically, the first protective layer 114 and the second protective layer 124 are made of triacetate cellulose, polymethyl methacrylate, or polyethylene terephthalate. The first protective layer 114 and the second protective layer 124 serve as protective layers of the polarizing layers, function to block water vapor, and also serve as a support for an entire polarizer.

Please refer to FIG. 4, which is a second schematic structural view of a display device provided by the present application. A difference between this embodiment and the embodiment shown in FIG. 1 is that the first polarizer 110 further includes a first support layer 115 disposed between the first polarizing layer 113 and the first liquid crystal compensation layers 111, and the second polarizer 120 further includes a second support layer 125 disposed between the second polarizing layer 123 and the second liquid crystal compensation layer 121.

The first support layer 115 is configured to protect and support the first polarizing layer 113 and prevent the first polarizing layer 113 from shrinking. The second support layer 125 is configured to protect and support the second polarizing layer 123 and prevent the second polarizing layer 123 from shrinking Each of the first support layer 115 and the second support layer 125 is a triacetate cellulose film having functions of blocking water vapor and supporting due to its characteristics of high-water resistance, low thermal shrinkage, and high durability. Therefore, the first support layer 115 can protect and support the first polarizing layer 113 and prevent the first polarizing layer 113 from shrinking. In addition, since the first support layer 115 is a non-compensation layer, it does not need to undergo special processing, and thus manufacturing cost is low. Furthermore, the second support layer 125 may protect and support the second polarizing layer 123 and prevent the second polarizing layer 123 from shrinking. Since the second support layer 125 is a non-compensation layer, it does not need to undergo special processing, and thus manufacturing cost is low.

In addition, opposite two sides of the liquid crystal display panel 130 of the present application are arranged symmetrically, number of film layers on each side is the same, and thickness of the film layers on each side is the same, so that a situation of bending due to different stress on both sides of the liquid crystal display panel 130 can be prevented.

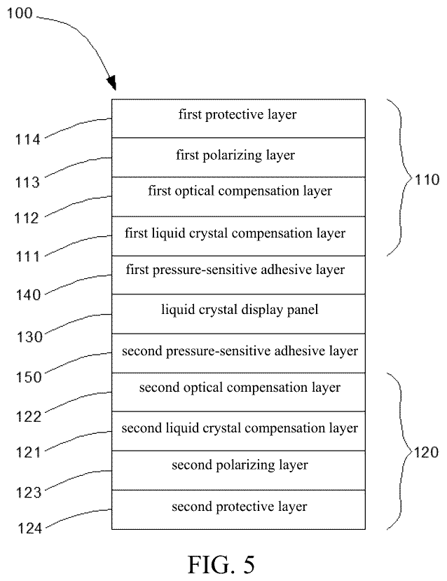

Please refer to FIG. 5, which is a third schematic structural view of the display device 100 provided by the present application. A difference between this embodiment and the embodiment shown in FIG. 1 is that the first optical compensation layer 112 is located between the first polarizing layer 113 and the first liquid crystal compensation layer 111, and the second liquid crystal compensation layer 121 is located between the second polarizing layer 123 and the second optical compensation layer 122. That is, the first polarizing layer 113, the first optical compensation layer 112, and the first liquid crystal compensation layer 111 are sequentially laminated. The second polarizing layer 123, the second liquid crystal compensation layer 121, and the second optical compensation layer 122 are sequentially laminated.

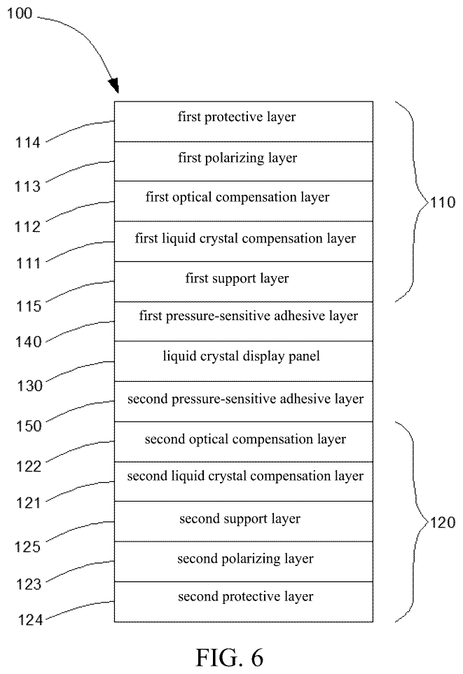

Please refer to FIG. 6, which is a fourth schematic structural view of the display device 100 provided by the present application. A difference between this embodiment and the embodiment shown in FIG. 5 is that the first polarizer 110 further includes a first support layer 115 disposed between the first liquid crystal compensation layer 111 and the liquid crystal display panel 130, and the second polarizer 120 further includes a second support layer 125 disposed between the second polarizing layer 123 and the second liquid crystal compensation layer 121.

The first support layer 115 is configured to protect and support the first liquid crystal compensation layer 111 and prevent the first liquid crystal compensation layer 111 from shrinking. The second support layer 125 is configured to protect and support the second polarizing layer 123 and prevent the second polarizing layer 123 from shrinking Each of the first support layer 115 and the second support layer 125 is a triacetate cellulose film having functions of blocking water vapor and providing support due to its characteristics of high-water resistance, low thermal shrinkage, and high durability. Therefore, the first support layer 115 can protect and support the first liquid crystal compensation layer 111 and prevent the first liquid crystal compensation layer 111 from shrinking. In addition, since the first support layer 115 is a non-compensation layer, it does not need to undergo special processing, and thus manufacturing cost is low. Furthermore, the second support layer 125 may protect and support the second polarizing layer 123 and prevent the second polarizing layer 123 from shrinking Since the second support layer 125 is a non-compensation layer, it does not need to undergo special processing, and thus manufacturing cost is low.

In addition, opposite two sides of the liquid crystal display panel 130 of the present application are arranged symmetrically, number of film layers on each side is the same, and thickness of the film layers on each side is the same, so that a situation of bending due to different stress on both sides of the liquid crystal display panel 130 can be prevented.

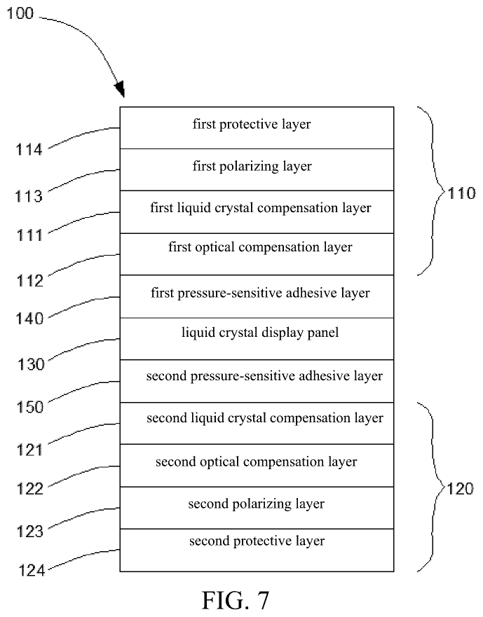

Please refer to FIG. 7, which is a fifth schematic structural view of the display device 100 provided by the present application. A difference between this embodiment and the embodiment shown in FIG. 1 is that the first liquid crystal compensation layer 111 is located between the first polarizing layer 113 and the first optical compensation layer 112, and the second optical compensation layer 122 is located between the second polarizing layer 123 and the second liquid crystal compensation layer 121. That is, the first polarizing layer 113, the first liquid crystal compensation layer 111, and the first optical compensation layer 112 are sequentially laminated. The second polarizing layer 123, the second optical compensation layer 122, and the second liquid crystal compensation layer 121 are sequentially laminated.

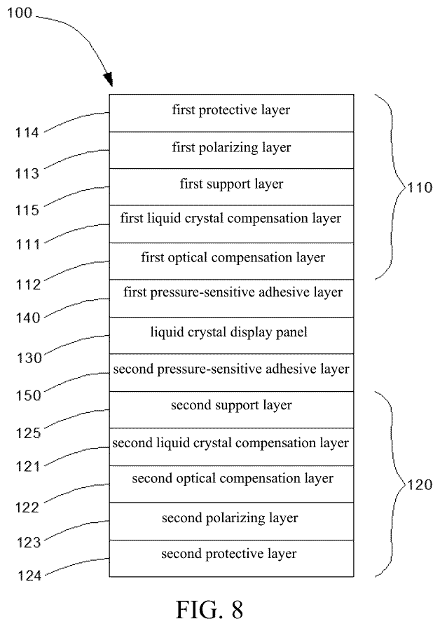

Please refer to FIG. 8, which is a sixth schematic structural view of the display device 100 provided by the present application. A difference between this embodiment and the embodiment shown in FIG. 7 is that the first polarizer 110 further includes a first support layer 115 disposed between the first polarizing layer 113 and the first liquid crystal compensation layer 111, and the second polarizer 120 further includes a second support layer 125 disposed between the second liquid crystal compensation layer 121 and the liquid crystal display panel 130.

The first support layer 115 is configured to protect and support the first polarizing layer 113 and prevent the first polarizing layer 113 from shrinking. The second support layer 125 is configured to protect and support the second liquid crystal compensation layer 121 and prevent the second liquid crystal compensation layer 121 from shrinking Each of the first support layer 115 and the second support layer 125 is a triacetate cellulose film having functions of blocking water vapor and providing support due to its characteristics of high-water resistance, low thermal shrinkage, and high durability. Therefore, the first support layer 115 can protect and support the first polarizing layer 113 and prevent the first polarizing layer 113 from shrinking. In addition, since the first support layer 115 is a non-compensation layer, it does not need to undergo special processing, and thus manufacturing cost is low. Furthermore, the second support layer 125 can protect and support the second liquid crystal compensation layer 121 and prevent the second liquid crystal compensation layer 121 from shrinking Since the second support layer 125 is a non-compensation layer, it does not need to undergo special processing, and thus manufacturing cost is low.

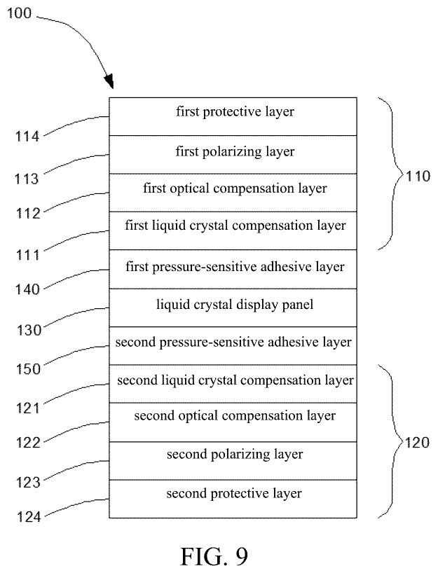

Please refer to FIG. 9, which is a seventh schematic structural view of the display device 100 provided by the present application. A difference between this embodiment and the embodiment shown in FIG. 1 is that the first optical compensation layer 112 is located between the first polarizing layer 113 and the first liquid crystal compensation layer 111, and the second optical compensation layer 122 is located between the second polarizing layer 123 and the second liquid crystal compensation layer 121. That is, the first polarizing layer 113, the first optical compensation layer 112, and the first liquid crystal compensation layer 111 are sequentially laminated. The second polarizing layer 123, the second optical compensation layer 122, and the second liquid crystal compensation layer 121 are sequentially laminated.

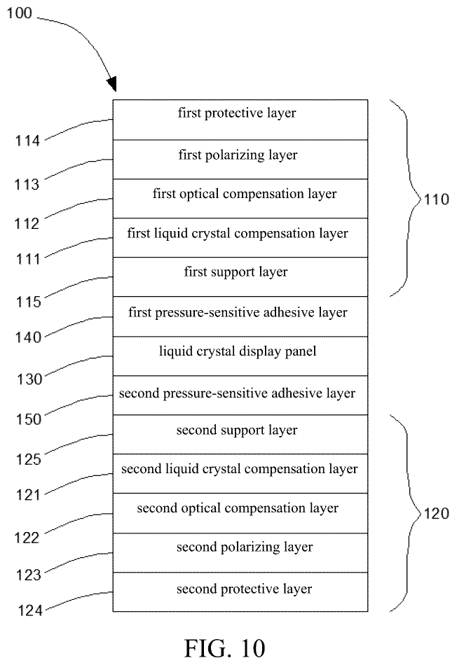

Please refer to FIG. 10, which is an eighth schematic structural view of the display device 100 provided by the present application. A difference between this embodiment and the embodiment shown in FIG. 9 is that the first polarizer 110 further includes a first support layer 115 disposed between the first liquid crystal compensation layer 111 and the liquid crystal display panel 130, and the second polarizer 120 further includes a second support layer 125 disposed between the second liquid crystal compensation layer 121 and the liquid crystal display panel 130.

The first support layer 115 is configured to protect and support the first liquid crystal compensation layer 111 and prevent the first liquid crystal compensation layer 111 from shrinking. The second support layer 125 is configured to protect and support the second liquid crystal compensation layer 121 and prevent the second liquid crystal compensation layer 121 from shrinking Each of the first support layer 115 and the second support layer 125 is a triacetate cellulose film having functions of blocking water vapor and providing support due to its characteristics of high-water resistance, low thermal shrinkage, and high durability. Therefore, the first support layer 115 can protect and support the first liquid crystal compensation layer 111 and prevent the first liquid crystal compensation layer 111 from shrinking. In addition, since the first support layer 115 is a non-compensation layer, it does not need to undergo special processing, and thus manufacturing cost is low. Furthermore, the second support layer 125 can protect and support the second liquid crystal compensation layer 121 and prevent the second liquid crystal compensation layer 121 from shrinking. Since the second support layer 125 is a non-compensation layer, it does not need to undergo special processing, and thus manufacturing cost is low.

In addition, opposite two sides of the liquid crystal display panel 130 of the present application are arranged symmetrically, number of film layers is the same on each side, and thickness of the film layers is the same on each side, so that a situation of bending due to different stress on both sides of the liquid crystal display panel 130 can be prevented.

The above describes in detail the display device provided in the embodiments of the present application. Specific examples are used in this article to illustrate the principles and implementation of the application, and the descriptions of the above examples are only used to help understand the methods and core ideas of the application; In addition, for those skilled in the art, according to the idea of the application, there will be changes in the specific implementation and the scope of application. In summary, the content of this specification should not be construed as a limitation of the application.

What is claimed is:

1. A display device, comprising:
a first polarizer;
a second polarizer disposed opposite to the first polarizer;
a liquid crystal display panel disposed between the first polarizer and the second polarizer;
wherein the first polarizer comprises a first liquid crystal compensation layer and a first optical compensation layer, and the second polarizer comprises a second liquid crystal compensation layer and a second optical compensation layer.

2. The display device of claim 1, wherein the first polarizer further comprises:
a first polarizing layer, wherein the first liquid crystal compensation layer and the first optical compensation layer are located between the first polarizing layer and the liquid crystal display panel; and
wherein the second polarizer further comprises:
a second polarizing layer, wherein the first liquid crystal compensation layer and the first optical compensation layer are located between the first polarizing layer and the liquid crystal display panel.

3. The display device of claim 1, wherein each of the first liquid crystal compensation layer and the second liquid crystal compensation layer comprises a liquid crystal polymer.

4. The display device of claim 2, wherein the first liquid crystal compensation layer is located between the first polarizing layer and the first optical compensation layer, and the second liquid crystal compensation layer is located between the second polarizing layer and the second optical compensation layer.

5. The display device of claim 4, wherein the first polarizer further comprises:
a first support layer disposed between the first polarizing layer and the first liquid crystal compensation layer; and
wherein the second polarizer further comprises:
a second support layer disposed between the second polarizing layer and the second liquid crystal compensation layer.

6. The display device of claim 2, wherein the first optical compensation layer is located between the first polarizing layer and the first liquid crystal compensation layer, and the second liquid crystal compensation layer is located between the second polarizing layer and the second optical compensation layer.

7. The display device of claim 6, wherein the first polarizer further comprises:
a first support layer arranged between the first liquid crystal compensation layer and the liquid crystal display panel; and
wherein the second polarizer further comprises:
a second support layer disposed between the second polarizing layer and the second liquid crystal compensation layer.

8. The display device of claim 2, wherein the first liquid crystal compensation layer is located between the first polarizing layer and the first optical compensation layer, and the second optical compensation layer is located between the second polarizing layer and the second liquid crystal compensation layer.

9. The display device of claim 8, wherein the first polarizer further comprises:
a first support layer disposed between the first polarizing layer and the first liquid crystal compensation layer; and
wherein the second polarizer further comprises:
a second support layer arranged between the second liquid crystal compensation layer and the liquid crystal display panel.

10. The display device of claim 2, wherein the first optical compensation layer is located between the first polarizing layer and the first liquid crystal compensation layer, and the second optical compensation layer is located between the second polarizing layer and the second liquid crystal compensation layer.

11. The display device of claim 10, wherein the first polarizer further comprises:
a first support layer arranged between the first liquid crystal compensation layer and the liquid crystal display panel; and
wherein the second polarizer further comprises:
a second support layer arranged between the second liquid crystal compensation layer and the liquid crystal display panel.

12. The display device of claim 2, wherein the first polarizer further comprises:
a first protective layer located on a side of the first polarizing layer away from the liquid crystal display panel; and
wherein the second polarizer further comprises:
a second protective layer located on a side of the second polarizing layer away from the liquid crystal display panel.

13. The display device of claim 12, wherein the first protective layer and the second protective layer are made of triacetate cellulose, polymethyl methacrylate, or polyethylene terephthalate.

14. The display device of claim 1, wherein each of the first optical compensation layer and the second optical compensation layer comprises a single optical axis compensation film or a dual optical axis compensation film.

15. A display device, comprising:
a first polarizer;
a second polarizer disposed opposite to the first polarizer; and
a liquid crystal display panel disposed between the first polarizer and the second polarizer;
wherein the first polarizer comprises a first liquid crystal compensation layer and a first optical compensation layer; and
the second polarizer comprises a second liquid crystal compensation layer and a second optical compensation layer;
wherein the first polarizer serves as a light incident side and the second polarizer serves as a light output side.

16. The display device of claim 15, wherein the first polarizer further comprises:
a first polarizing layer, wherein the first liquid crystal compensation layer and the first optical compensation layer are located between the first polarizing layer and the liquid crystal display panel; and
wherein the second polarizer further comprises:
a second polarizing layer, wherein the first liquid crystal compensation layer and the first optical compensation layer are located between the first polarizing layer and the liquid crystal display panel.

17. The display device of claim 16, wherein the first liquid crystal compensation layer is located between the first polarizing layer and the first optical compensation layer, and the second liquid crystal compensation layer is located between the second polarizing layer and the second optical compensation layer.

18. The display device of claim 17, wherein the first polarizer further comprises:
a first support layer disposed between the first polarizing layer and the first liquid crystal compensation layer; and
wherein the second polarizer further comprises:
a second support layer disposed between the second polarizing layer and the second liquid crystal compensation layer.

19. The display device of claim 16, wherein the first optical compensation layer is located between the first polarizing layer and the first liquid crystal compensation layer, and the second liquid crystal compensation layer is located between the second polarizing layer and the second optical compensation layer.

20. The display device of claim 19, wherein the first polarizer further comprises:
a first support layer arranged between the first liquid crystal compensation layer and the liquid crystal display panel; and
wherein the second polarizer further comprises:
a second support layer disposed between the second polarizing layer and the second liquid crystal compensation layer.
